(19) United States
(12) Patent Application Publication
(10) Pub. No.: US 2011/0043340 A1
(43) Pub. Date: Feb. 24, 2011

(54) Concatenated Repetition Code with Convolutional Code

(75) Inventors: Il Han Kim, Dallas, TX (US); Badri N. Varadarajan, Dallas, TX (US); Anand G. Dabak, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/849,676

(22) Filed: Aug. 3, 2010

Related U.S. Application Data
(60) Provisional application No. 61/242,263, filed on Sep. 14, 2009.
(60) Provisional application No. 61/235,156, filed on Aug. 19, 2009.

(51) Int. Cl. G05B 11/01

(52) U.S. Cl. 340/310.12

(57) ABSTRACT

A system and method for modulating and coding a signal is disclosed. Data from a Media Access Control (MAC) layer is convolutionally encoded. Robust coding of the data from the MAC layer is performed either before or after the convolutional encoding. The coded data is differentially modulating and then Orthogonal Frequency Division Multiplexed to create an OFDM output signal adapted to be transmitted on a power line network. The robust coding may be a repetition 2 coding or a repetition N coding. The robust coding may add an outer code prior to the convolutional encoding. The robust coding may be Reed Solomon coding performed prior to the convolutional encoding. An optional header for identifying the robust coding is also disclosed along with a method for decoding the header.

### CROSS-REFERENCE TO RELATED APPLICATIONS

The present application claims the benefit of the filing date of U.S. Provisional Patent Application No. 61/242,263, which is titled “Concatenated Repetition Code with Convolutional Code for PRIME Solution” and filed Sep. 14, 2009, and claims the benefit of the filing date of U.S. Provisional Patent Application No. 61/235,156, which is titled “Concatenated Repetition Code with Convolutional Code for PRIME Solution” and filed Aug. 19, 2009, the disclosures of which are hereby incorporated by reference herein in their entirety.

### TECHNICAL FIELD

Embodiments of the invention are directed, in general, to communication systems and, more specifically, to methods of coding packets using a concatenated repetition code.

### BACKGROUND

There has been a lot of interest in the use of power lines as communication media to reduce the cost of reliable communications. This is generally referred to as power line communications (PLC). There have been standardization efforts for PLC, such as Powerline-Related Intelligent Metering Evolution (PRIME), which is a draft standard for OFDM-based (Orthogonal Frequency-Division Multiplexing) power line technology that operates in the 40-90 kHz CENELEC A band. The current or existing PRIME standard referred to herein is the PRIME R1.3E Draft Standard prepared by the PRIME Alliance Technical Working Group (“PRIME R1.3E”) and earlier versions thereof.

FIG. 1 illustrates a typical electric power distribution system connecting substation 101 to residences 102a-n. Medium voltage (MV) power lines 103 from substation 101 carry voltage in the tens of kilovolts range. Transformer 104 steps the MV power down to low voltage (LV) power on LV lines 105 carrying voltage in the range of 100-240 VAC. Transformer 104 is typically designed to operate at very low frequencies in the range of 50-60 Hz. Transformer 104 does not allow high frequencies, such as signals greater than 100 KHz, to pass between LV lines 105 and MV lines 103. LV lines 105 feed power to customers via meters 106a-n, which are typically mounted on the outside of residences 102a-n. A breaker panel, such as panel 107 provides an interface between meter 106n and electrical wires 108 within residence 102n. Electrical wires 108 deliver power to outlets 110, switches 111 and other electric devices within residence 102n.

The power line topology illustrated in FIG. 1 can be used to deliver high-speed communications to residences 102a-n. Power line communications modems 112a-n may be coupled to LV power lines 105 at meter 106a-n. PLC modems 112a-n are used to transmit and receive data signals over MV/LV lines 103, 105. Such data signals may be used to support communication systems, high speed Internet, telephony, video conferencing, video delivery and similar services. By transporting telecommunications and data signals over a power transmission network, there is no need to install new cabling to each subscriber 102a-n. Thus, by using existing electricity distribution systems to carry data signals, significant cost savings are possible. One method for transmitting data over power lines uses a carrier signal having a frequency different from that of the power signal. The carrier signal is modulated by the data to be transmitted. Alternatively, PLC modem 113 may be coupled to the MV/LV power lines via home electrical lines 108 to transmit and receive the data signals.

PLC modems 112a-n at residences 102a-n use the MV/LV power grid to carry data signals to and from concentrator 114 without requiring additional wiring. Concentrator 114 may be coupled to either MV line 103 or LV line 105. Modems 112a-n may support applications such as high-speed broadband internet links, narrowband control applications, and low bandwidth data collection applications. In a home environment, modems 112a-n may enable home and building automation in heat and air conditioning, lighting and security. Outside the home, power line communication networks provide street lighting control and remote power meter data collection.

A problem with using a power line network as a communications medium is that the power lines are subject to noise and interference. Power line cables are susceptible, for example, to noise from AM band broadcast radio signals, maritime communications, and electrical equipment coupled to the power lines. Noise propagates along the power lines and combines with communications signals, which may corrupt the communications signals. Another problem with using power line networks is caused by the structure of the cable. On MV and LV power lines, the inner section of the cable comprises a group of phase lines, each carrying one of the three supply phases. At radio frequencies, the capacitance between these separate lines causes the signals on one line to leak or couple onto the neighboring lines. The coupling process between phase lines may introduce a phase shift or other interference. Therefore, after propagating along the lines, the components of a communications signal on each line will no longer be in phase with each other, but will be of different phase and amplitude. Such coupling and interference cause problems with receiving equipment, which must attempt to decode the modified received signal and reconstruct the original signal.

The existing PRIME system operates well on low voltage (LV) power lines. However, the channel environments are more severe on medium voltage (MV) lines. For example, MV lines have higher background noise power than LV lines and, therefore, reliable communication may not be possible on MV lines.

### SUMMARY OF THE INVENTION

Embodiments of the invention provide more reliable communication in the severe channel environments of PLC networks by changing the forward error correction (FEC) used in the current PRIME system.

The coding systems described herein can coexist with the existing PRIME R1.3E draft standard and are simple to implement without requiring major changes to the PRIME R1.3E draft standard. This disclosure describes a new coding scheme with a concatenated repetition code that resolves the problems associated with transmitting over noisy MV and LV power lines. A PHY layer Protocol Data Unit (PPDU) format that is backward compatible with the current PRIME R1.3E draft standard is also described herein. The modified PRIME system described below is referred to herein as a “robust PRIME” system.

Embodiments of the invention provide more robust coding to the current PRIME system. The coding may include, for example, adding a Reed Solomon code (RS code) or repetition code to transmitted PPDUs so that they data can be recovered after transmission over noisy MV and LV lines. The current PRIME system supports up to 63 OFDM symbols, where each OFDM symbol in the payload carries 96 data subcarriers and 1 pilot subcarrier. RS code supports up to a maximum of 255 output bytes, which limits the number of symbols that can be RS coded at one time. The modulation type also affects the number of symbols that can be RS coded at one time. Embodiments of the invention divide data to be transmitted by the robust PRIME system into smaller subparts that can be processed by the RS coder. For example, if the robust PRIME system needs to transmit 63 symbols, those symbols must first be partitioned into smaller groups each having no more symbols than can be RS coded for the selected modulation method. The robust PRIME system may predefine the manner in which large-symbol groups are partitioned into subgroups so that each robust PRIME transmitter and receiver treats each group the same way.

The robust PRIME system uses a modified PPDU header in one embodiment to support robust MCS. To support robust data decoding, the receiver must be able to decode the header. Therefore, it is advisable to increase the robustness of the header. In one embodiment, the current PRIME methodology of using the most robust (i.e. lowest data rate) MCS for the header is retained. An alternative embodiment uses an even more robust scheme for header encoding than for the data encoding.

PPDUs having the robust PRIME format must coexist with PPDUs having the current PRIME format. In one embodiment, a PRIME R1.3E receiver must be able to identify and decode received PRIME R1.3E PPDUs, and must not decode robust PRIME PPDUs as PRIME R1.3E PPDUs. In a preferred embodiment, the header of the robust PRIME PPDU is selected so that a PRIME R1.3E receiver is unlikely to get a false positive CRC. A robust PRIME receiver may receive and decode both PRIME R1.3E and robust PRIME PPDUs. The format of the PPDU header should be selected to meet these conditions.

In one embodiment, a transmitter comprises a convolutional encoder and a robust coder coupled to the convolutional encoder. The convolutional encoder and robust coder receive data from a Media Access Control (MAC) layer and create a coded signal. A differential modulator generates a differentially modulated signal from the coded signal. An Orthogonal Frequency Division Multiplexing (OFDM) circuit coupled to the differential modulator generates an OFDM output signal adapted to be transmitted on a power line network. The robust coder may be a repetition 2 code circuit coupled to an output of the convolutional encoder or coupled to an input of the differential modulator. The robust coder may add a repetition N code to the data from the MAC layer in place of a repetition 2 code. Alternatively, the robust coder may add an outer code prior to the convolutional encoder. The outer code may be a Reed Solomon code. The robust coder may partition the data from the MAC layer into subgroups, each of the subgroups having a size less than 256 bytes. The sizes of each subgroup may be selected based upon a type of modulation applied by the differential modulator.

In another embodiment, a device modulates and codes a signal. Data from a Media Access Control (MAC) layer is convolutionally encoded. Robust coding of the data from the MAC layer is performed either before or after the convolutional encoding. The coded data is differentially modulating and then Orthogonal Frequency Division Multiplexed to create an OFDM output signal adapted to be transmitted on a power line network. The robust coding may be repetition 2 coding or repetition N coding. The robust coding may add an outer code prior to the convolutional encoding. The robust coding may be Reed Solomon coding performed prior to the convolutional encoding.

In a further embodiment, a signal is decoded by receiving a PHY protocol data unit (PPDU) from a power line network and decoding a first header in the PPDU. The system then verifyes whether the first header was successfully decoded according to a first format. A second header in the PPDU is then decoded, and the system verifies whether the second header was successfully decoded according to a second format. A payload in the PPDU is then decoded according to either the first or second format. The first format may be a PRIME R1.3E format. The second format may identify modulation and coding not available in the PRIME R1.3E format. The method for decoding the PPDU payload is determined depending upon whether either or both of the first header and the second header were successfully decoded.

### BRIEF DESCRIPTION OF THE DRAWINGS

Having thus described the invention in general terms, reference will now be made to the accompanying drawings, wherein:

FIG. 1 illustrates a system for three phase power line communication;

FIG. 2 illustrates the components of a PHY transmitter according to the PRIME R1.3E draft standard;

FIG. 3 illustrates the components of a PHY transmitter using a repetition code at the output of the convolutional encoder;

FIG. 4 illustrates the components of a PHY transmitter with a repetition code is placed after an interleaver block;

FIG. 5 illustrates the components of a PHY transmitter in which an outer code, such as a Reed Solomon code, is added;

FIG. 6 illustrates packet having a header field according to the PRIME R1.3E draft standard;

FIG. 7 illustrates an exemplary robust PRIME packet format according to one embodiment;

FIG. 8 illustrates a PPDU header field according to the PRIME R1.3E draft standard;

FIG. 9 illustrates an exemplary procedure used by a PRIME R1.3E receiver to decode a received PPDU;

FIG. 10 illustrates an exemplary procedure used by a robust PRIME receiver to decode a received PPDU, and

FIG. 11 illustrates the components of a PHY transmitter in which an outer code, such as a Reed Solomon code, is added before the convolutional encoder and a repetition 2 code is added after the convolutional encoder;

FIG. 12A illustrates DBPSK mapping for frequency domain differential modulation;

FIG. 12B illustrates DQPSK mapping for frequency domain differential modulation;

FIG. 12C illustrates D8PSK mapping for frequency domain differential modulation;

FIG. 13 illustrates subcarrier mapping in an IFFT according to one embodiment;

FIG. 14 illustrates a data frame structure according to an alternative embodiment;

FIG. 15 illustrates an Acknowledgement (ACK)/Negative Acknowledgement frame according to an alternative embodiment;

FIG. 16A illustrates data encoding for BPSK, DBPSK and Robust modulation according to an alternative embodiment;

, DBPSK and DQPSK is illustrated in FIGS. 16A and B

FIG. 16B illustrates data encoding for DQPSK modulation according to an alternative embodiment;

FIG. 17 illustrates the input/output configuration of an IFFT according to one embodiment;

FIG. 18 illustrates a connection between power line communications transmitter and/or receiver circuitry to three phase power lines;

FIG. 19 illustrates an alternative connection between a power line communications transmitter and/or receiver circuitry and the three phase power lines; and

FIG. 20 illustrates another alternative connection between power line communications transmitter and/or receiver circuitry and the three phase power line.

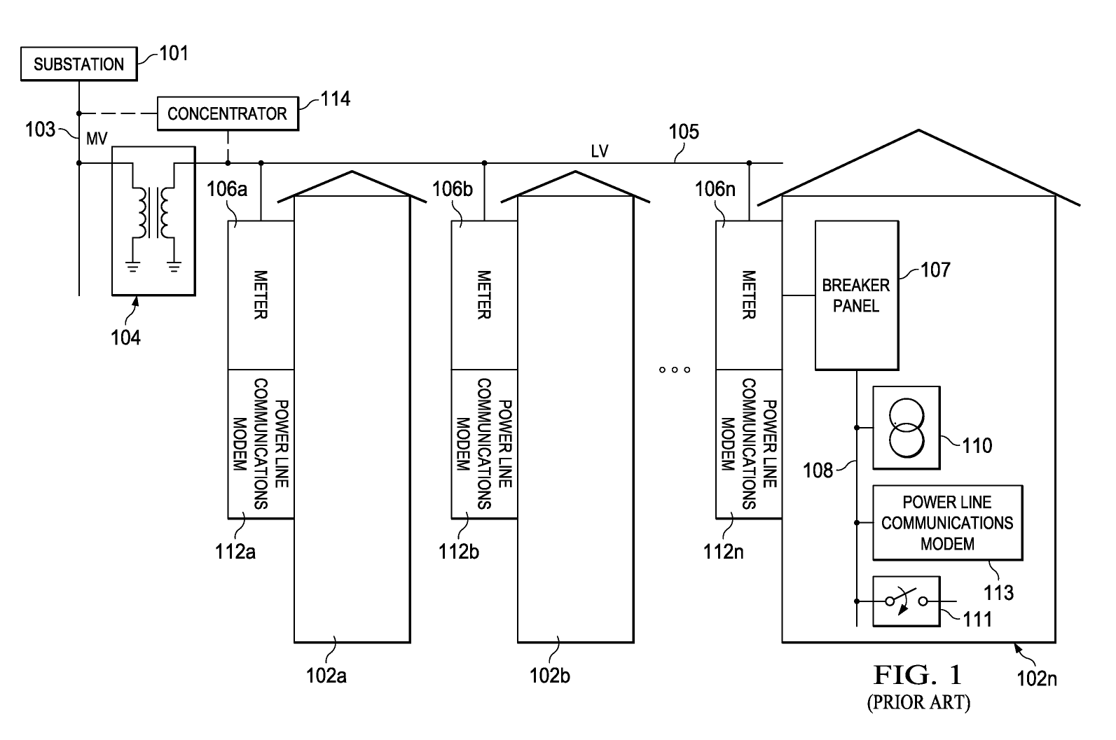

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

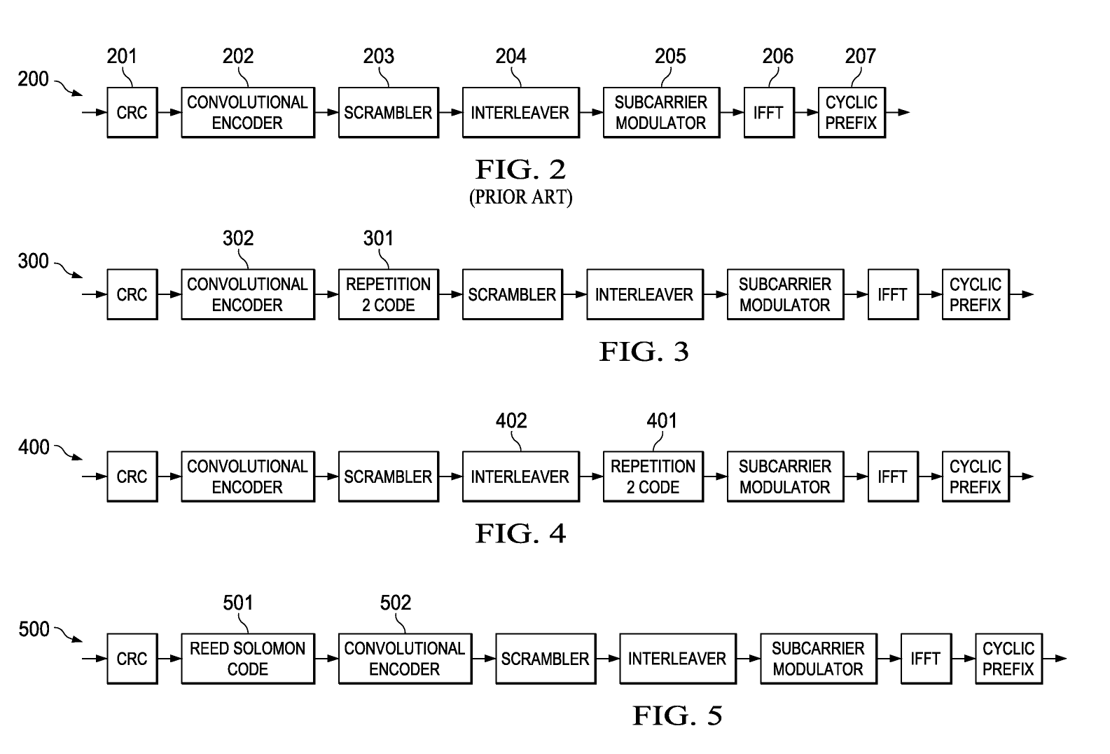

FIG. 2 illustrates a PRIME PHY R1.3E transmitter 200 according to the existing PRIME standard. The PHY layer receives PPDU inputs from the Media Access Control (MAC) layer. The PPDU passes through Cyclic Redundancy Check (CRC) block 201 and then is convolutionally encoded in Convolutional Encoder 202 and scrambled in Scrambler 203. The output of Scrambler 203 is interleaved in Interleaver 204 and then differentially modulated in subcarrier modulator 205. The modulation uses a Differential Binary Phase Shift Keying (DBPSK), Differential Quaternary Phase Shift Keying (DQPSK) or Differential Eight-Phase Shift Keying (D8PSK) scheme. OFDM is performed in Inverse Fast Fourier Transform (IFFT) block 206 and the cyclic prefix generator 207. The forward error correction (FEC) in transmitter 200 is rate ½ convolutional coding with the constraint length 7.

It has been shown that the transmission methods described in the existing PRIME standard, such as the modulation and coding employed in transmitter 200, works well in typical LV networks. However, some changes are needed to enhance the performance in severe channel environments, such as in the noisier MV networks. Specifically, another modulation and coding scheme (MCS) can be added to the PRIME standard to reduce the lowest tolerable signal-to-noise ratio (SNR) for reliable communications. However, the proposed change to the modulation and coding scheme results in a reduced data rate.

The present PRIME standard supports six MCS: DBPSK, DQPSK or D8PSK modulations, each either with or without a rate ½ convolutional code. It has been observed that the lowest data rate of these modulation and coding schemes requires approximately 4 db SNR to achieve a 10⁻⁵ bit error rate (BER) on an additive white Gaussian noise (AWGN) channel. It may be desirable for a PRIME system to operate at a lower SNR. In order to function at a lower SNR, the PRIME system requires more robust modulation and coding schemes (MCS), which may consequently reduce the data rate of the system.

In one embodiment, the MCS set may be enhanced by adding a repetition code at the output of the convolutional code. For example, FIG. 3 illustrates a PHY transmitter 300 using repetition 2 code 301 at the output of the convolutional encoder 302. A repetition 2 code is known to give a 3 dB SNR improvement on an AWGN channel and may provide a higher level of enhancement for other channel profiles. One advantage of the transmitter embodiment shown in FIG. 3 is that it is simple to implement. With minimal changes to the existing PRIME standard, the repetition 2 code can be added to the existing PRIME PHY transmitter. It will be understood that a repetition N code can be added as necessary instead of repetition 2 code.

FIG. 4 illustrates another embodiment in which repetition code 401 is placed after interleaver block 402 in PHY transmitter 400. Repetition code 401 may be repetition 2 code or a repetition N code.

FIG. 5 illustrates a further embodiment, in which an outer code, such as a Reed Solomon code, is added to the PHY transmitter 500. Reed Solomon code (RS code) 501 is added as an outer code before convolutional encoder 502. Reed Solomon code is well-known for use in correcting burst errors. Based on the number of symbols in one PPDU and using Galois field (GF) 2⁸, the RS parameters (n,k,t) can be determined as described below. The number of convolutional code output bits is given by the product of the number of OFDM symbols (N_{SYM}), the number of modulated carriers per symbol (N_{SC}, equal to 96 in PRIME R1.3E), and the number of bits per modulated carrier (N_{MB}, equal to 1, 2 and 3 for DBPSK, DQPSK and D8PSK, respectively). Accordingly, the number of Reed Solomon code output bytes is calculated as:

$${N}_{RS \text{-} OUT} = \frac{1}{8} ( ( {N}_{SYM} \cdot {N}_{SC} \cdot {N}_{MB} \cdot {R}_{CC} ) - {P}_{CC} ) \qquad Eq . 1$$

where the rate R_{CC} of the convolutional code is 1 or ½ and the number of pad bits P_{CC} is 0 or 8, respectively, for rates 1 and ½.

Shortened Reed Solomon codes (255, 255-2*t) can be used for t=4 and t=8. For reasons of coding efficiency, one embodiment uses t=4.

The formulation shown in Equation 1 works for all cases, except when
1. N_{RS-OUT}<t: This occurs when the number of symbols per PPDU goes below a minimum number, which depends on the modulation and coding scheme used. In one embodiment, small PPDU sizes (i.e. below a minimum number) are invalid to enable Reed-Solomon coding.
2. N_{RS-OUT}>255: This occurs, for example, when the number of OFDM symbols for DBPSK, rate ½ coding exceeds 42, or when the number of OFDM symbols for DQPSK, rate ½ coding exceeds 21, or when the number of OFDM symbols for D8PSK, rate ½ coding exceeds 14.

In one embodiment, to handle packets where N_{RS-OUT}>255, the input packet is segmented into Reed Solomon packets of nearly equal size. The number of segments is calculated as S=ceil(N_{RS-OUT})/255. Defining N_{SEG}=floor(N_{RS-OUT}/S) and M_{SEG}=mod(N_{RS-OUT}, S), the number of Reed Solomon output bytes from the s^{th} segment equals (1+N_{SEG}) for s=1, . . . , M_{SEG} and N_{SEG} for s=M_{SEG}+1, . . . , S.

Tables 1, 2 and 3 provide the Reed Solomon parameters for DBPSK, DQPSK, and DBPSK, respectively. The RS code parameters are solely dependent on the number of OFDM symbols and the selected modulation scheme. No other parameterization is needed in the PPDU header to denote this RS encoder information. The number of padding bits to the input to the RS encoder does not exceed 6 bytes. Therefore, the pad length information can be recorded using the fields in the PPDU header.

For DBPSK with 39 OFDM symbols per PPDU, one PPDU with this scheme can carry ((39·96 ·1 ·½)−8)=1864 bits as the input to the convolutional encoder. With eight flushing bits in the PRIME payload format for convolutional coding, this corresponds to n=233 bytes. The corresponding k can be decided by t.

As shown in Table 1, RS coding will work with DBPSK for up to 42 OFDM symbols. For DBPSK with more than 42 OFDM symbols per PPDU, the value of n is exceeded. For example, for DBPSK with 43 OFDM symbols, one PPDU can carry ((43·96·1·½)−8)=2056 bits as the input to the convolutional encoder. This corresponds to n=257 bytes, which is greater than the limit of 255. In this case, the 43 OFDM symbols can be divided by two or more subgroups of symbols (e.g., a group of 21 OFDM symbols and a group of 22 OFDM symbols). The two subgroups of OFDM symbols are then encoded separately by the RS encoder using the data in Table 1. The resulting bits of the two RS encoder outputs are then encoded by a convolutional encoder. To save the header information bits, the combination may be predefined in one embodiment. To match the PPDU size, 8 more zeros can be used to turn the convolutional encoder into zero state. In the above example of a 43-OFDM-symbol PPDU, two groups of 21 and 22 symbols are encoded separately. This results in n=125 and n=131 from Table 1, respectively, for the two groups of symbols. By putting 8 more zeros to the convolutional encoder, the number of output bits from the convolutional encoder is (125·8+131·8+8+8)·2=4128 bits, which fits to 4128/96=43 OFDM symbols. For PPDU lengths greater than 43, a similar process can be applied by breaking the PPDU down into two or more smaller symbols subsets. Optimal combinations of RS encoding for PPDUs with more than 42 OFDM symbols can be determined by simulation. For the other MCS schemes, the same argument can be applied as described above for the DBPSK case. The PPDU header can be designed separately as necessary.

The data shown in Table 1 below corresponds to a DBPSK RS encoder.

TABLE 1

| Number of | | | | | |
|---|---|---|---|---|---|
| OFDM | | | | Rate 1 | Rate 2 |
| symbols | n | k1 (t = 4) | k2 (t = 8) | (kbps) | (kbps) |
| 42 | 251 | 243 | 235 | 20.6633 | 19.9830 |
| 41 | 245 | 237 | 229 | 20.6446 | 19.9477 |
| 40 | 239 | 231 | 223 | 20.6250 | 19.9107 |
| 39 | 233 | 225 | 217 | 20.6044 | 19.8718 |
| 38 | 227 | 219 | 211 | 20.5827 | 19.8308 |
| 37 | 221 | 213 | 205 | 20.5598 | 19.7876 |
| 36 | 215 | 207 | 199 | 20.5357 | 19.7421 |
| 35 | 209 | 201 | 193 | 20.5102 | 19.6939 |
| 34 | 203 | 195 | 187 | 20.4832 | 19.6429 |
| 33 | 197 | 189 | 181 | 20.4545 | 19.5887 |
| 32 | 191 | 183 | 175 | 20.4241 | 19.5313 |
| 31 | 185 | 177 | 169 | 20.3917 | 19.4700 |
| 30 | 179 | 171 | 163 | 20.3571 | 19.4048 |
| 29 | 173 | 165 | 157 | 20.3202 | 19.3350 |
| 28 | 167 | 159 | 151 | 20.2806 | 19.2602 |
| 27 | 161 | 153 | 145 | 20.2381 | 19.1799 |
| 26 | 155 | 147 | 139 | 20.1923 | 19.0934 |
| 25 | 149 | 141 | 133 | 20.1429 | 19.0000 |
| 24 | 143 | 135 | 127 | 20.0893 | 18.8988 |
| 23 | 137 | 129 | 121 | 20.0311 | 18.7888 |
| 22 | 131 | 123 | 115 | 19.9675 | 18.6688 |
| 21 | 125 | 117 | 109 | 19.8980 | 18.5374 |
| 20 | 119 | 111 | 103 | 19.8214 | 18.3929 |
| 19 | 113 | 105 | 97 | 19.7368 | 18.2331 |
| 18 | 107 | 99 | 91 | 19.6429 | 18.0556 |
| 17 | 101 | 93 | 85 | 19.5378 | 17.8571 |
| 16 | 95 | 87 | 79 | 19.4196 | 17.6339 |
| 15 | 89 | 81 | 73 | 19.2857 | 17.3810 |
| 14 | 83 | 75 | 67 | 19.1327 | 17.0918 |
| 13 | 77 | 69 | 61 | 18.9560 | 16.7582 |
| 12 | 71 | 63 | 55 | 18.7500 | 16.3690 |
| 11 | 65 | 57 | 49 | 18.5065 | 15.9091 |
| 10 | 59 | 51 | 43 | 18.2143 | 15.3571 |
| 9 | 53 | 45 | 37 | 17.8571 | 14.6825 |
| 8 | 47 | 39 | 31 | 17.4107 | 13.8393 |
| 7 | 41 | 33 | 25 | 16.8367 | 12.7551 |
| 6 | 35 | 27 | 19 | 16.0714 | 11.3095 |
| 5 | 29 | 21 | 13 | 15.0000 | 9.2857 |
| 4 | 23 | 15 | 7 | 13.3929 | 6.2500 |
| 3 | 17 | 9 | 1 | 10.7143 | 1.1905 |
| 2 | 11 | 3 | N/A | 5.3571 | N/A |
| 1 | 5 | N/A | N/A | N/A | N/A |

The data shown in Table 2 below corresponds to a DQPSK RS encoder.

TABLE 2

| Number of | | | | | |
|---|---|---|---|---|---|
| OFDM | | | | Rate 1 | Rate 2 |
| symbols | n | k1 (t = 4) | k2 (t = 8) | (kbps) | (kbps) |
| 21 | 251 | 243 | 235 | 41.3265 | 39.9660 |
| 20 | 239 | 231 | 223 | 41.2500 | 39.8214 |
| 19 | 227 | 219 | 211 | 41.1654 | 39.6617 |
| 18 | 215 | 207 | 199 | 41.0714 | 39.4841 |
| 17 | 203 | 195 | 187 | 40.9664 | 39.2857 |
| 16 | 191 | 183 | 175 | 40.8482 | 39.0625 |
| 15 | 179 | 171 | 163 | 40.7143 | 38.8095 |
| 14 | 167 | 159 | 151 | 40.5612 | 38.5204 |
| 13 | 155 | 147 | 139 | 40.3846 | 38.1868 |
| 12 | 143 | 135 | 127 | 40.1786 | 37.7976 |
| 11 | 131 | 123 | 115 | 39.9351 | 37.3377 |
| 10 | 119 | 111 | 103 | 39.6429 | 36.7857 |
| 9 | 107 | 99 | 91 | 39.2857 | 36.1111 |
| 8 | 95 | 87 | 79 | 38.8393 | 35.2679 |
| 7 | 83 | 75 | 67 | 38.2653 | 34.1837 |
| 6 | 71 | 63 | 55 | 37.5000 | 32.7381 |
| 5 | 59 | 51 | 43 | 36.4286 | 30.7143 |
| 4 | 47 | 39 | 31 | 34.8214 | 27.6786 |
| 3 | 35 | 27 | 19 | 32.1429 | 22.6190 |
| 2 | 23 | 15 | 7 | 26.7857 | 12.5000 |
| 1 | 11 | 3 | N/A | 10.7143 | N/A |

The data shown in Table 3 below corresponds to a D8PSK RS encoder.

TABLE 3

| Number of | | | | | |
|---|---|---|---|---|---|
| OFDM | | | | Rate 1 | Rate 2 |
| symbols | n | k1 (t = 4) | k2 (t = 8) | (kbps) | (kbps) |
| 14 | 251 | 243 | 235 | 61.9898 | 59.9490 |
| 13 | 233 | 225 | 217 | 61.8132 | 59.6154 |
| 12 | 215 | 207 | 199 | 61.6071 | 59.2262 |
| 11 | 197 | 189 | 181 | 61.3636 | 58.7662 |
| 10 | 179 | 171 | 163 | 61.0714 | 58.2143 |
| 9 | 161 | 153 | 145 | 60.7143 | 57.5397 |
| 8 | 143 | 135 | 127 | 60.2679 | 56.6964 |
| 7 | 125 | 117 | 109 | 59.6939 | 55.6122 |
| 6 | 107 | 99 | 91 | 58.9286 | 54.1667 |
| 5 | 89 | 81 | 73 | 57.8571 | 52.1429 |
| 4 | 71 | 63 | 55 | 56.2500 | 49.1071 |
| 3 | 53 | 45 | 37 | 53.5714 | 44.0476 |
| 2 | 35 | 27 | 19 | 48.2143 | 33.9286 |
| 1 | 17 | 9 | 1 | 32.1429 | 3.5714 |

Tables 4-6 show the RS parameters (n, k, t) when a repetition 2 code is used as an inner code. These are exemplary tables and may readily be extended with repetition N code. To send more OFDM symbols than the number of symbols listed in the tables, the system can partition the OFDM symbols into smaller subsets as described above. For example, 43 OFDM symbols with DBPSK and with no convolutional code can be partitioned into subgroups of 22 symbols and 21 symbols. These partitions can be independently encoded as 22 OFDM symbols and 21 OFDM symbols with the RS encoder. Then, the two RS encoder output streams are jointly encoded by the convolutional encoder. The optimum partition of large OFDM symbol PPDUs can be decided from simulation results.

The data shown in Table 4 below corresponds to a DBPSK RS encoder with repetition 2 code as an inner code.

TABLE 4

| Number of | | | | | |
|---|---|---|---|---|---|
| OFDM | | | | Rate 1 | Rate 2 |
| symbols | n | k1 (t = 4) | k2 (t = 8) | (kbps) | (kbps) |
| 42 | 125 | 117 | 109 | 9.9490 | 9.2687 |
| 41 | 122 | 114 | 106 | 9.9303 | 9.2334 |
| 40 | 119 | 111 | 103 | 9.9107 | 9.1964 |
| 39 | 116 | 108 | 100 | 9.8901 | 9.1575 |
| 38 | 113 | 105 | 97 | 9.8684 | 9.1165 |
| 37 | 110 | 102 | 94 | 9.8456 | 9.0734 |
| 36 | 107 | 99 | 91 | 9.8214 | 9.0278 |
| 35 | 104 | 96 | 88 | 9.7959 | 8.9796 |
| 34 | 101 | 93 | 85 | 9.7689 | 8.9286 |
| 33 | 98 | 90 | 82 | 9.7403 | 8.8745 |
| 32 | 95 | 87 | 79 | 9.7098 | 8.8170 |
| 31 | 92 | 84 | 76 | 9.6774 | 8.7558 |
| 30 | 89 | 81 | 73 | 9.6429 | 8.6905 |
| 29 | 86 | 78 | 70 | 9.6059 | 8.6207 |
| 28 | 83 | 75 | 67 | 9.5663 | 8.5459 |
| 27 | 80 | 72 | 64 | 9.5238 | 8.4656 |
| 26 | 77 | 69 | 61 | 9.4780 | 8.3791 |
| 25 | 74 | 66 | 58 | 9.4286 | 8.2857 |
| 24 | 71 | 63 | 55 | 9.3750 | 8.1845 |
| 23 | 68 | 60 | 52 | 9.3168 | 8.0745 |
| 22 | 65 | 57 | 49 | 9.2532 | 7.9545 |
| 21 | 62 | 54 | 46 | 9.1837 | 7.8231 |
| 20 | 59 | 51 | 43 | 9.1071 | 7.6786 |
| 19 | 56 | 48 | 40 | 9.0226 | 7.5188 |
| 18 | 53 | 45 | 37 | 8.9286 | 7.3413 |
| 17 | 50 | 42 | 34 | 8.8235 | 7.1429 |
| 16 | 47 | 39 | 31 | 8.7054 | 6.9196 |
| 15 | 44 | 36 | 28 | 8.5714 | 6.6667 |
| 14 | 41 | 33 | 25 | 8.4184 | 6.3776 |
| 13 | 38 | 30 | 22 | 8.2418 | 6.0440 |
| 12 | 35 | 27 | 19 | 8.0357 | 5.6548 |
| 11 | 32 | 24 | 16 | 7.7922 | 5.1948 |
| 10 | 29 | 21 | 13 | 7.5000 | 4.6429 |
| 9 | 26 | 18 | 10 | 7.1429 | 3.9683 |
| 8 | 23 | 15 | 7 | 6.6964 | 3.1250 |
| 7 | 20 | 12 | 4 | 6.1224 | 2.0408 |
| 6 | 17 | 9 | 1 | 5.3571 | 0.5952 |
| 5 | 14 | 6 | N/A | 4.2857 | N/A |
| 4 | 11 | 3 | N/A | 2.6786 | N/A |
| 3 | 8 | N/A | N/A | N/A | N/A |
| 2 | 5 | N/A | N/A | N/A | N/A |
| 1 | 2 | N/A | N/A | N/A | N/A |

The data shown in Table 5 below corresponds to a DQPSK RS encoder with repetition 2 code as an inner code.

TABLE 5

| Number of | | | | | |
|---|---|---|---|---|---|
| OFDM | | | | Rate 1 | Rate 2 |
| symbols | n | k1 (t = 4) | k2 (t = 8) | (kbps) | (kbps) |
| 21 | 125 | 117 | 109 | 19.8980 | 18.5374 |
| 20 | 119 | 111 | 103 | 19.8214 | 18.3929 |
| 19 | 113 | 105 | 97 | 19.7368 | 18.2331 |
| 18 | 107 | 99 | 91 | 19.6429 | 18.0556 |
| 17 | 101 | 93 | 85 | 19.5378 | 17.8571 |
| 16 | 95 | 87 | 79 | 19.4196 | 17.6339 |
| 15 | 89 | 81 | 73 | 19.2857 | 17.3810 |
| 14 | 83 | 75 | 67 | 19.1327 | 17.0918 |
| 13 | 77 | 69 | 61 | 18.9560 | 16.7582 |
| 12 | 71 | 63 | 55 | 18.7500 | 16.3690 |
| 11 | 65 | 57 | 49 | 18.5065 | 15.9091 |
| 10 | 59 | 51 | 43 | 18.2143 | 15.3571 |
| 9 | 53 | 45 | 37 | 17.8571 | 14.6825 |
| 8 | 47 | 39 | 31 | 17.4107 | 13.8393 |
| 7 | 41 | 33 | 25 | 16.8367 | 12.7551 |
| 6 | 35 | 27 | 19 | 16.0714 | 11.3095 |
| 5 | 29 | 21 | 13 | 15.0000 | 9.2857 |
| 4 | 23 | 15 | 7 | 13.3929 | 6.2500 |
| 3 | 17 | 9 | 1 | 10.7143 | 1.1905 |
| 2 | 11 | 3 | N/A | 5.3571 | N/A |
| 1 | 5 | N/A | N/A | N/A | N/A |

The data shown in Table 6 below corresponds to a D8PSK RS encoder with repetition 2 code as an inner code.

TABLE 6

| Number | | | | | |
|---|---|---|---|---|---|
| of OFDM | | | | Rate 1 | Rate 2 |
| symbols | n | k1 (t = 4) | k2 (t = 8) | (kbps) | (kbps) |
| 14 | 125 | 117 | 109 | 29.8469 | 27.8061 |
| 13 | 116 | 108 | 100 | 29.6703 | 27.4725 |
| 12 | 107 | 99 | 91 | 29.4643 | 27.0833 |
| 11 | 98 | 90 | 82 | 29.2208 | 26.6234 |
| 10 | 89 | 81 | 73 | 28.9286 | 26.0714 |
| 9 | 80 | 72 | 64 | 28.5714 | 25.3968 |
| 8 | 71 | 63 | 55 | 28.1250 | 24.5536 |
| 7 | 62 | 54 | 46 | 27.5510 | 23.4694 |
| 6 | 53 | 45 | 37 | 26.7857 | 22.0238 |
| 5 | 44 | 36 | 28 | 25.7143 | 20.0000 |
| 4 | 35 | 27 | 19 | 24.1071 | 16.9643 |
| 3 | 26 | 18 | 10 | 21.4286 | 11.9048 |
| 2 | 17 | 9 | 1 | 16.0714 | 1.7857 |
| 1 | 8 | N/A | N/A | N/A | N/A |

When no convolutional coder is used, the RS coding can still be used. For this case, the RS parameters (n,k,t) are described in Tables 7-9. As noted above, to send more than the number of OFDM symbols described in the tables, the PPDU may be partitioned into subparts each with a smaller number of OFDM symbols. For example, DBPSK will work for up to 21 OFDM symbols. If a PPDU has 42 OFDM symbols with DBPSK and with no convolutional code, the PPDU can be partitioned into two 21-OFDM-symbol subparts. The 21-OFDM-symbol subparts are then independently encoded in the RS encoder. The optimum partition for large PPDUs can be decided from simulation results.

The data shown in Table 7 below corresponds to a DBPSK RS encoder without convolutional encoding.

TABLE 7

| Number of | | | | | |
|---|---|---|---|---|---|
| OFDM | | | | Rate 1 | Rate 2 |
| symbols | n | k1 (t = 4) | k2 (t = 8) | (kbps) | (kbps) |
| 21 | 252 | 244 | 236 | 41.4966 | 40.1361 |
| 20 | 240 | 232 | 224 | 41.4286 | 40.0000 |
| 19 | 228 | 220 | 212 | 41.3534 | 39.8496 |
| 18 | 216 | 208 | 200 | 41.2698 | 39.6825 |
| 17 | 204 | 196 | 188 | 41.1765 | 39.4958 |
| 16 | 192 | 184 | 176 | 41.0714 | 39.2857 |
| 15 | 180 | 172 | 164 | 40.9524 | 39.0476 |
| 14 | 168 | 160 | 152 | 40.8163 | 38.7755 |
| 13 | 156 | 148 | 140 | 40.6593 | 38.4615 |
| 12 | 144 | 136 | 128 | 40.4762 | 38.0952 |
| 11 | 132 | 124 | 116 | 40.2597 | 37.6623 |
| 10 | 120 | 112 | 104 | 40.0000 | 37.1429 |
| 9 | 108 | 100 | 92 | 39.6825 | 36.5079 |
| 8 | 96 | 88 | 80 | 39.2857 | 35.7143 |
| 7 | 84 | 76 | 68 | 38.7755 | 34.6939 |
| 6 | 72 | 64 | 56 | 38.0952 | 33.3333 |
| 5 | 60 | 52 | 44 | 37.1429 | 31.4286 |
| 4 | 48 | 40 | 32 | 35.7143 | 28.5714 |
| 3 | 36 | 28 | 20 | 33.3333 | 23.8095 |
| 2 | 24 | 16 | 8 | 28.5714 | 14.2857 |
| 1 | 12 | 4 | N/A | 14.2857 | −14.2857 |

The data shown in Table 8 below corresponds to a DQPSK RS encoder without convolutional encoding.

TABLE 8

| Number | | | | | |
|---|---|---|---|---|---|
| of OFDM | | | | Rate 1 | Rate 2 |
| symbols | n | k1 (t = 4) | k2 (t = 8) | (kbps) | (kbps) |
| 10 | 240 | 232 | 224 | 82.8571 | 80.0000 |
| 9 | 216 | 208 | 200 | 82.5397 | 79.3651 |
| 8 | 192 | 184 | 176 | 82.1429 | 78.5714 |
| 7 | 168 | 160 | 152 | 81.6327 | 77.5510 |
| 6 | 144 | 136 | 128 | 80.9524 | 76.1905 |
| 5 | 120 | 112 | 104 | 80.0000 | 74.2857 |
| 4 | 96 | 88 | 80 | 78.5714 | 71.4286 |
| 3 | 72 | 64 | 56 | 76.1905 | 66.6667 |
| 2 | 48 | 40 | 32 | 71.4286 | 57.1429 |
| 1 | 24 | 16 | 8 | 57.1429 | 28.5714 |

The data shown in Table 9 below corresponds to a D8PSK RS encoder without convolutional encoding.

TABLE 9

| Number of | | | | | |
|---|---|---|---|---|---|
| OFDM | | | | Rate 1 | Rate 2 |
| symbols | n | k1 (t = 4) | k2 (t = 8) | (kbps) | (kbps) |
| 7 | 252 | 244 | 236 | 124.4898 | 120.4082 |
| 6 | 216 | 208 | 200 | 123.8095 | 119.0476 |
| 5 | 180 | 172 | 164 | 122.8571 | 117.1429 |
| 4 | 144 | 136 | 128 | 121.4286 | 114.2857 |
| 3 | 108 | 100 | 92 | 119.0476 | 109.5238 |
| 2 | 72 | 64 | 56 | 114.2857 | 100.0000 |
| 1 | 36 | 28 | 20 | 100.0000 | 71.4286 |

Other embodiments include using a lower rate convolutional code, or using a turbo code with two convolutional codes. While these embodiments are more complex and have significant differences from PRIME R1.3E, a transmitter with a lower rate convolutional code or a turbo code will also provide robust MCS.

The following section identifies exemplary PPDU header changes that support robust MCS. In order to support robust data decoding, the receiver must first be able to decode the header. Therefore, it is advisable to increase the robustness of the header. In one embodiment, the current PRIME methodology of using the most robust (i.e. lowest data rate) MCS for the header is retained. An alternative embodiment uses an even more robust scheme for header encoding than for the data encoding.

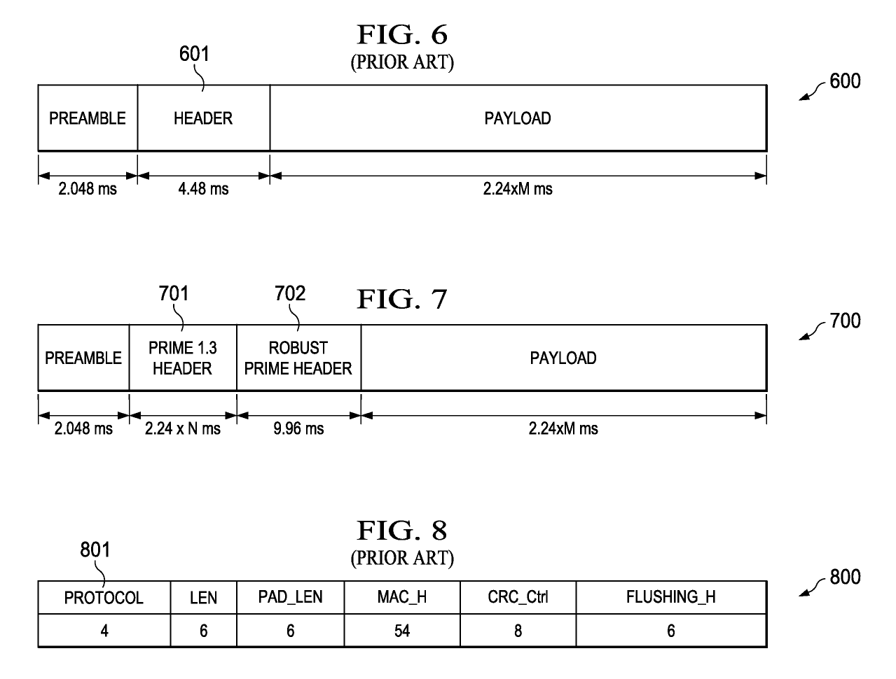

For the same spectral efficiency, some schemes are clearly better than others. For instance, DQPSK with a rate ½ code has the same rate as DBPSK-uncoded and performs better than the uncoded DBPSK. Taking this into account, some schemes can be removed to simplify testing. An exemplary MCS set for the header is given below in Table 10. The PRIME PPDU header includes a 4 bit Protocol field. FIG. 6 illustrates a PRIME R1.3E draft standard packet 600 having header field 601 including a 4 bit Protocol field. The code in the Protocol field identifies the modulation and coding scheme (MCS) used to encode the PPDU. In a robust PRIME system, certain MCS entries, such as DBPSK, no coding and DQPSK, no coding, are not used if they do not provide sufficient performance. Additional MCS, such as DBPSK, rate ½ code with repetition and DQPSK, rate ½ code with repetition, are added to a robust PRIME system.

TABLE 10

| Protocol field | MCS in current | MCS in robust |
|---|---|---|
| (4 bits) | PRIME standard | PRIME format |
| 0000 | DBPSK, no coding | RESERVED |
| 0001 | DQPSK, no coding | RESERVED |
| 0010 | D8PSK, no coding | D8PSK, no coding |
| 0011 | RESERVED | RESERVED |
| 0100 | DBPSK, rate 1/2 code | DBPSK, rate 1/2 code |
| 0101 | DQPSK, rate 1/2 code | DQPSK, rate 1/2 code |
| 0110 | D8PSK, rate 1/2 code | D8PSK, rate 1/2 code |
| 0111 | RESERVED | DBPSK, rate 1/2 code |
| | | with repetition |
| 1000 | RESERVED | DQPSK, rate 1/2 code |
| | | with repetition |
| 1001 | RESERVED | RESERVED |
| 1010 | RESERVED | RESERVED |
| 1011 | RESERVED | RESERVED |
| 1100 | RESERVED | RESERVED |
| 1101 | RESERVED | RESERVED |
| 1110 | RESERVED | RESERVED |
| 1111 | RESERVED | RESERVED |

In one embodiment, the robust PRIME system maintains backward compatibility with the current PRIME R1.3E draft standard. The header modulation and coding scheme for the robust PRIME system may use a single packet format having the most robust modulation and coding scheme for the header. However, this configuration would not backward compatible, since PRIME R1.3E receivers would not be able to decode the robust PRIME header. Alternatively, robust PRIME receivers would be capable of receiving and decoding packets from PRIME R1.3E transmitters.

In another embodiment, robust PRIME modems may transmit and receive both PRIME R1.3E and robust PRIME packets. Thus, a robust PRIME modem would transmit PRIME R1.3E packets when communicating with a PRIME R1.3E modem, and would transmit a robust PRIME packet when communicating with another robust PRIME modem. To support this mode, robust PRIME modems would need to indicate their version number during initial connection setup to other robust PRIME modems. Thereafter, for further communication between two robust PRIME modems, the robust PRIME packet format may be used. In an alternative embodiment, two robust PRIME modems may use PRIME R1.3E packets to communicate when the link between them is good, and use the robust PRIME format when the link is not good.

A problem with the above embodiments is the behavior of a PRIME R1.3E receiver in the vicinity of many robust PRIME modems. Note that a PRIME R1.3E receiver on the same line would detect the PPDU preambles transmitted by neighboring robust PRIME modems and would attempt to decode the PPDU headers as if they were in the PRIME R1.3E format. Since the CRC length is 8 bits, roughly 1/256 of these header decodes will exhibit a false CRC pass. For these false positives, the PRIME R1.3E receiver may then make incorrect use of the packets, resulting in unstable network behavior.

At least two solutions exist for the problem noted above. One solution is to require that the robust PRIME header be used only when PRIME R1.3E MCS format does not provide sufficiently robust communication. However, such a requirement may not translate well to actual operating conditions when, for example, the SNR varies on the line or when the SNR degrades after a transmitter and receiver agree to use PRIME R1.3E PPDUs.

A second, more reliable solution uses the robust PRIME packet format as shown below in FIG. 7. In robust PRIME packet 700, a valid PRIME R1.3E format header 701 is embedded inside the robust PRIME packet in addition to a robust PRIME header 702. Thus, a neighboring PRIME R1.3E receiver will correctly decode most robust PRIME packet headers, which will result in stable behavior. Further, as a precaution, some fields in the PRIME R1.3E header may use reserved field values to ensure that the PRIME R1.3E receiver does not attempt to decode the further part of the robust PRIME packet. Robust PRIME modems can communicate with PRIME R1.3E modems, but PRIME R1.3E modems still cannot receive the robust PRIME packets.

Backward compatibility with the existing PRIME R1.3E draft standard may be an important issue for use of the robust PRIME system. In one embodiment, the PPDU format for the PRIME R1.3E draft standard may be modified to make the robust PRIME system backward compatible with the existing PRIME R1.3E draft standard. FIG. 6 illustrates the existing PRIME R1.3E PPDU format 600. The first four bits in the PRIME header denotes the MCS information as shown in Table 10. To be backward compatible with the PRIME R1.3E draft standard, the robust PRIME PPDU format 700 illustrated in FIG. 7 is proposed with the repetition 2 code as an example. For other codes, the header length in the new PPDU can be changed. The header format for the robust PRIME PPDU 700 can be the PRIME R1.3E header format as given in FIG. 8 with the Protocol field 801 comprising the relevant bits from Table 10.

In the robust PRIME PPDU format 700, the bits for MCS information in the PRIME R1.3E header 701 may be set to the bits in the RESERVED sections in Table 10 outside the original sections in the PRIME R1.3E draft standard. Alternatively, the robust PRIME transmitter may add flag bits in the RESERVED sections to notify whether the PPDU complies with the robust PRIME standard or not.

For a PRIME R1.3E receiver, when a PRIME R1.3E PPDU is received and the header contains valid PRIME R1.3E PPDU information, such as the fields shown in FIG. 8, the PRIME R1.3E receiver decodes the payload as usual. If a robust PRIME PPDU is received, the PRIME R1.3E receiver first attempts to decode the header and finds the header information to be invalid for the PRIME R1.3E PPDU format. For example, the first four Protocol bits in the header may be set to PRIME R1.3E RESERVED bits. The receiver may discard the PPDU and/or higher the layers may take care of this PPDU by dealing with MAC address. Preferably, the PPDU length information is transferred to the higher layers for CSMA scheduling.

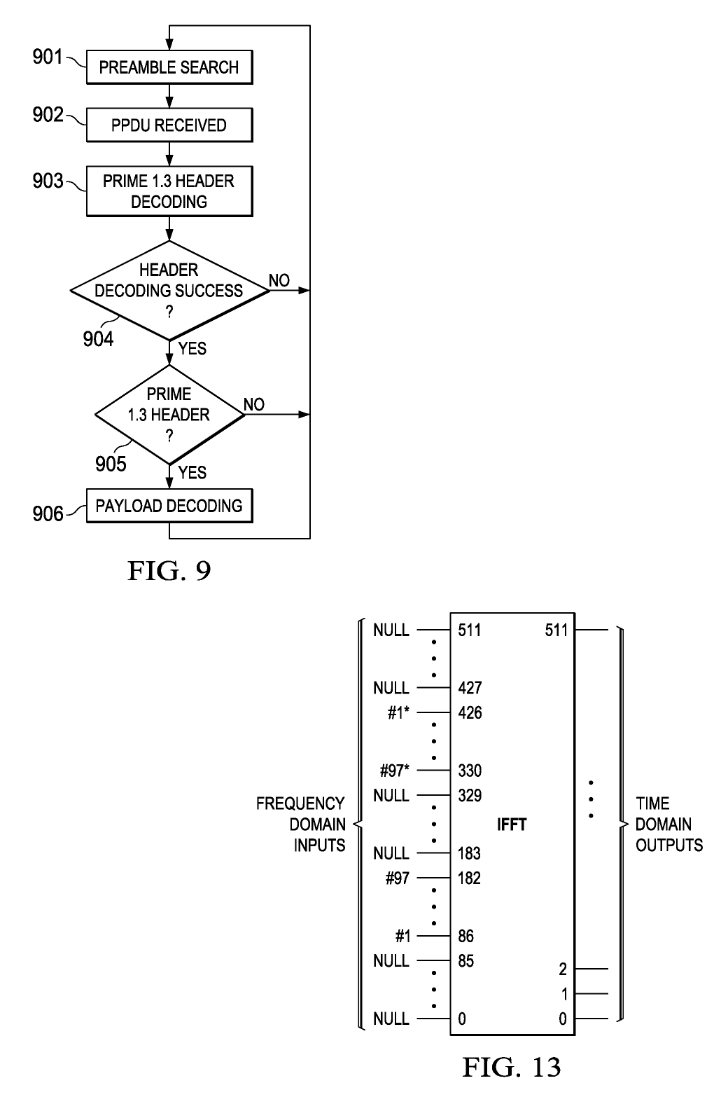

FIG. 9 illustrates an exemplary procedure used by a PRIME R1.3E receiver to decode a received PPDU. The PRIME R1.3E receiver searches for a PPDU preamble in step 901 to identify a received PPDU in step 902. The PRIME R1.3E receiver decodes the PPDU header in step 903 and evaluates whether the header was successfully decoded in step 904. If the header was not successfully decoded, the PRIME R1.3E receiver returns to step 901 to identify the next PPDU. If the header was successfully decoded, the PRIME R1.3E receiver determines whether the header is a PRIME R1.3E header in step 905. If the header is not a PRIME R1.3E header, then the process returns to step 901 to identify the next PPDU. Upon detection of a PRIME R1.3E header, the PRIME R1.3E receiver decodes the PPDU payload in step 906.

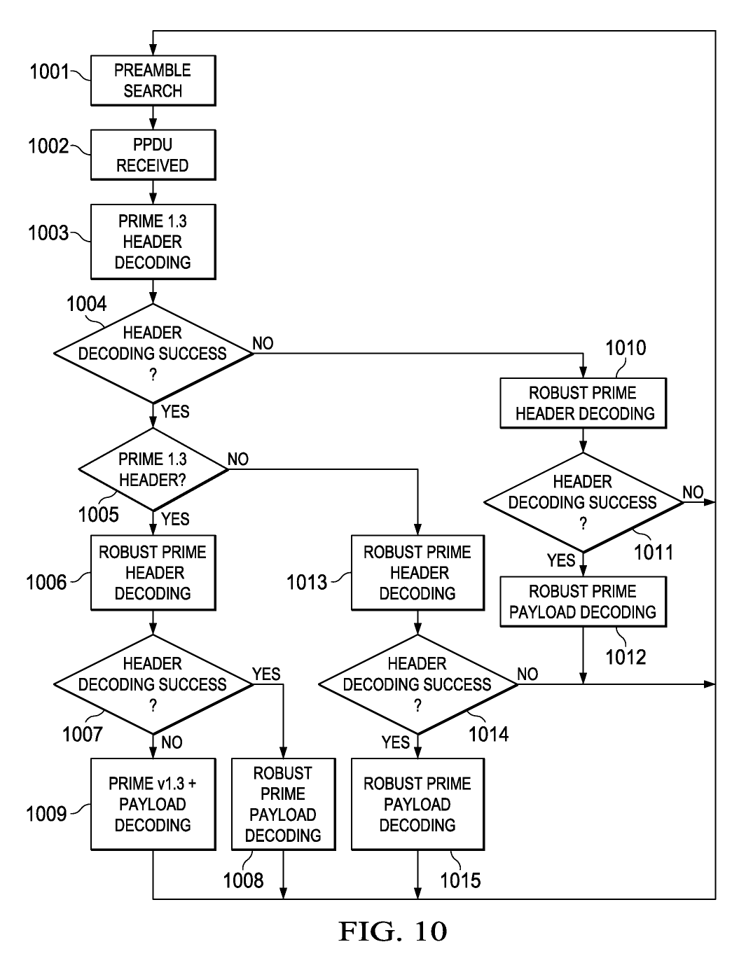

If appropriately designed, a robust PRIME receiver can decode both PRIME R1.3E PPDUs and robust PRIME PPDUs. FIG. 10 illustrates an exemplary procedure used by a robust PRIME receiver to decode a received PPDU. The robust PRIME receiver searches for a PPDU preamble in step 1001 to identify a received PPDU in step 1002. The robust PRIME receiver may receive PPDUs in the PRIME R1.3E format illustrated in FIG. 6 or in the robust PRIME format of FIG. 7. In either case, at step 1003, the robust PRIME receiver attempts to decode the PRIME R1.3E header from the PPDU with the rate ½ convolutional code and evaluates whether the header was successfully decoded in step 1004.

Assuming that the PPDU is in the PRIME R1.3E format, and that the decoding in step 1003 was successful, the process moves to step 1005 to confirm the PRIME R1.3E header. The bits corresponding to the RESERVED sections of the Protocol filed, as shown in the example of Table 10, will never occur in this case, and the robust PRIME receiver recognizes that the current PPDU is a PRIME R1.3E PPDU. Because the robust PRIME receiver could errorneously decode the PRIME R1.3E header and still pass the CRC, the robust PRIME receiver performs a second robust header decoding at step 1006 and evaluates whether the decoding was a success in step 1007. If the header passes the CRC in steps 1006 and 1007, then the PPDU is a robust PRIME packet and the process moves to step 1008 to do robust PRIME decoding. If the header fails the CRC in steps 1006 and 1007, then PRIME R1.3E decoding is performed in step 1009. The first four bits in the header describe the correct MCS information and after the correct header decoding, the robust PRIME receiver can decode the payload information.

In case that the robust PRIME receiver cannot decode the PRIME R1.3E header correctly in step 1004, the robust PRIME receiver tries to decode the robust PRIME header area of the PPDU at step 1010 even though decoding may be performed on the payload portion of the received PRIME R1.3E PPDU. If the CRC passes in the robust PRIME header at step 1011, then the robust PRIME payload is decoded at step 1012. If the CRC fails in the robust PRIME header at step 1011, then the process returns to step 1001 to search for the next PPDU.

When a robust PRIME PPDU is received at step 1002, the robust PRIME receiver first decodes the PRIME R1.3E header with the rate ½ convolutional code at step 1003. If the first four bits in the decoded header match the bits in the RESERVED sections shown in Table 10, then robust PRIME receiver recognizes that the current PPDU is a robust PRIME PPDU at step 1005. The robust PRIME receiver then identifies the robust PRIME header in the PPDU at step 1006. The robust PRIME receiver decodes the robust PRIME header at step 1006. Using the decoded bits in the robust PRIME header at step 1007, the robust PRIME receiver decodes the payload at step 1008.

In case that the robust PRIME receiver cannot decode the PRIME R1.3E header correctly at step 1005. The robust PRIME receiver attempts to decode the robust PRIME PPDU header at step 1013. Since the robust PRIME header is more robust than the PRIME R1.3E header, it is more likely that the robust PRIME header can be correctly decoded and identified in step 1014. If the robust PRIME header is identified in step 1014, then the payload is decoded in step 1015. Otherwise, the process returns to step 1001 to search for the next PPDU.

As illustrated in FIG. 6, the PRIME R1.3E preamble is 2.048 ms and is expected to support accurate detection and placement up to −2 dB SNR. If lower SNR operation is required, the preamble length should be increased. Different embodiments of providing a longer preamble are possible depending on whether backward compatibility is desired.

In one embodiment, the PRIME R1.3E preamble may be extended by repeating some samples in it. In another embodiment, the robust PRIME preamble may be two repeats of the PRIME R1.3E preamble. However, this embodiment has the disadvantage that PRIME R1.3E receivers in the vicinity will detect part of the preamble and will attempt to decode the remaining PPDU with erroneous preamble placement.

In another embodiment, the robust PRIME preamble contains a prefix sequence that is uncorrelated with the PRIME R1.3E preamble followed by the PRIME R1.3E preamble. This embodiment guarantees that PRIME R1.3E receivers in the vicinity will correctly detect the preamble and also obtain the correct preamble placement. In this embodiment, the prefix sequence may be chosen so that it yields a real sequence in “baseband” after down-conversion to the PRIME center frequency. This enables a simplified implementation of robust PRIME preamble detection.

In yet another embodiment, the robust PRIME preamble may be completely different from the PRIME R1.3E preamble. It may be chosen to have a real “baseband” equivalent for simplicity, as mentioned above. The disadvantage of this embodiment is that PRIME R1.3E receivers will not be able to detect the preamble and may incorrectly interpret the channel to be unoccupied.

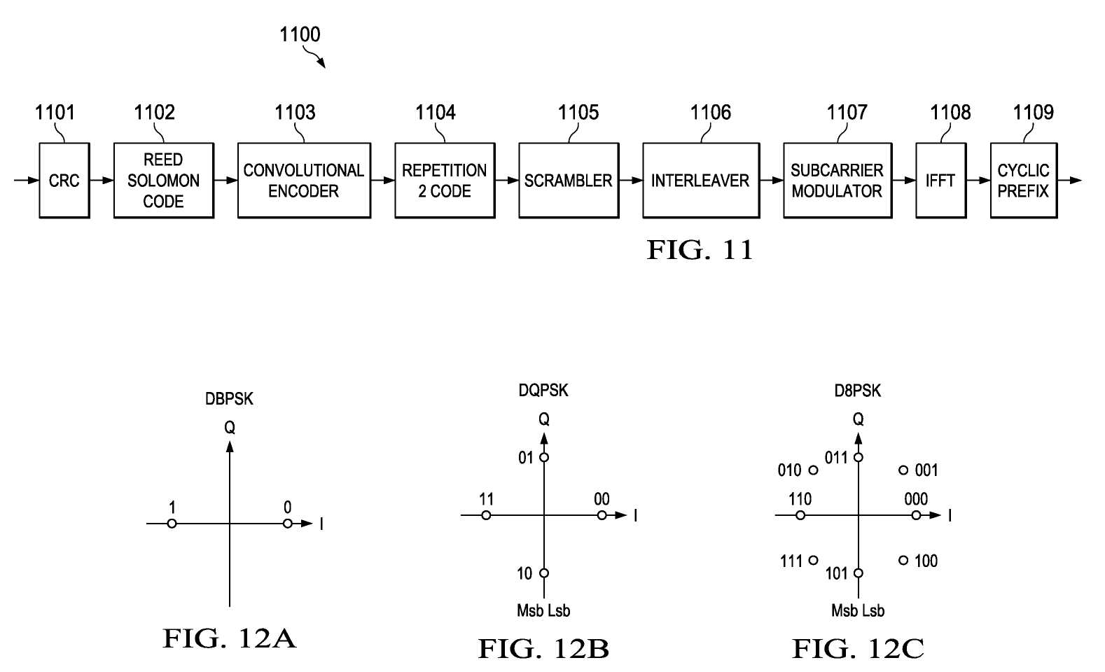

FIG. 11 illustrates another embodiment of a PRIME PHY transmitter 1100. The PHY layer receives PPDU inputs from the MAC layer. The PPDU passes through CRC block 1101 and then Reed Solomon code 1102 is added as an outer code. The RS parameters (n,k,t) can be determined as described above. After convolutional encoder 1103, repetition 2 code 1104 is added. It will be understood that a repetition N code can be added as necessary instead of repetition 2 code. Additionally, repetition 2 code 1104 may be located after interleaver 1106 in other embodiments. The signal is then scrambled in scrambler 1105 and interleaved in interleaver 1106. The signal is then differentially modulated in subcarrier modulator 1107. The modulation uses a Differential Binary Phase Shift Keying (DBPSK), Differential Quaternary Phase Shift Keying (DQPSK) or Differential Eight-Phase Shift Keying (DBPSK) scheme. OFDM is performed in Inverse Fast Fourier Transform (IFFT) block 1108 and the cyclic prefix generator 1109.

Transmitter 1100 can be used to generate PPDUs having the dual header format illustrated in FIG. 7. Additionally, such PPDUs could be decoded using the process illustrated in FIG. 10.

In one embodiment, such as in systems complying with the PRIME Physical Layer Specifications, frequency domain differential encoding is used to modulate the PPDUs. Such a system is disclosed in the document titled “Draft Standard for Powerline-Related Intelligent Metering Evolution,” version R1.3E, and published by the PRIME Project, the disclosure of which is hereby incorporated by reference herein in its entirety. The PPDU payload is modulated as a multicarrier differential phase shift keying (DPSK) signal with one pilot subcarrier and 96 data subcarriers that comprise 96, 192 or 288 bits per symbol. The PPDU header is modulated DBPSK with 13 pilot subcarriers and 84 data subcarriers that comprise 84 bits per symbol.

In the PRIME transmitter, the bit stream output from the interleaver is divided into groups of M bits where the first bit of the group of M is the most significant bit (msb).

PPDU is modulated with frequency domain differential modulation using the DBPSK, DQPSK or D8PSK mapping shown in FIGS. 12A-C, respectively. The following equation defines the M-ary DPSK constellation of M phases:

sₖ=Ae^{jθ}^{ₖ} Eq. 2

Where:

k is the frequency index representing the k-th subcarrier in an OFDM symbol, and k=1 corresponds to the phase reference pilot subcarrier;

s is the modulator output (a complex number) for a given subcarrier; and

θₖ stands for the absolute phase of the modulated signal obtained as follows:

θₖ=(θₖ₋₁+(2π/M)Δbₖ)mod 2π Eq. 3

This equation applies for k>1 in the payload, the k=1 subcarrier is the phase reference pilot. When the header is transmitted, the pilot allocated in the k-th subcarrier is used as a phase reference for the data allocated in the k+1-th subcarrier. Where:

Δbₖ ε{0, 1, . . . , M−1} represents the information coded in the phase increment, as supplied by the constellation encoder; and

M=2, 4, or 8 in the case of DBPSK, DQPSK or D8PSK, respectively.

Variable A is a shaping parameter and represents the ring radius from the centre of the constellation. It would be desirable for the rms power of the preamble to be similar to the rms power of the OFDM symbols in order to help an Automatic Gain Control task on the receiving part.

The OFDM symbol can be expressed in mathematical form:

$${c}_{i} ( n ) = \{ {\sum }_{k = 86}^{182} s ( k - 85 , i ) exp ( \frac{j 2 π k}{512} ( n - {N}_{CP} ) ) + {\sum }_{k = 330}^{426} s ( 427 - k , i ) * exp ( \frac{j 2 π k}{512} ( n - {N}_{CP} ) ) \} \qquad Eq . 4$$

Where:

i is the time index representing the i-th OFDM symbol; i=0, 1, . . . ;

n is the sample index; 48≦n≦559 (from 0 to 47 it represents the index of cyclic prefix (N_{CP}=48)); and

s(k,i) is the complex value from the subcarrier modulation block.

FIG. 13 illustrates subcarrier mapping for a complex 512-point IFFT used in one embodiment The 96 subcarriers are mapped as shown in FIG. 13, wherein the symbol * represents complex conjugate. After the inverse Fourier transform, the symbol is cyclically extended by 48 samples to create the cyclic prefix (N_{CP}).

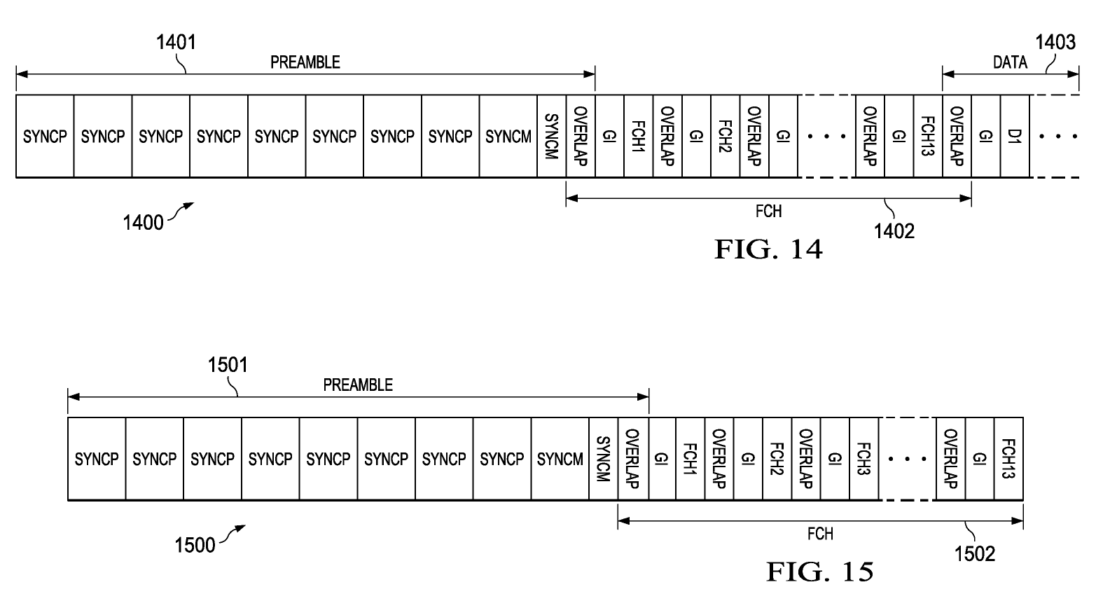

FIGS. 14 and 15 illustrate two types of frames supported by the PHY transmitter in an alternative embodiment. FIG. 14 illustrates a data frame structure 1400 for the OFDM PHY. Each frame starts with a preamble 1401, which is used for synchronization and detection in addition to automatic gain control adaptation. The SYNCP blocks refer to symbols that are multiplied by +1, and the SYNCM blocks refer to symbols multiplied by −1. The Preamble 1401 consists of eight SYNCP symbols followed by one and a half SYNCM symbols with no cyclic prefix between adjacent symbols. The first symbol includes raised cosine shaping on the leading points. The last half symbol also includes raised cosine shaping on the trailing points. The preamble is followed by thirteen data symbols allocated to Frame Control Header (FCH) 1402. FCH has the important control information required to demodulate the data frame. Data symbols 1403 are transmitted next. The GI blocks represent guard intervals, which are the intervals containing the cyclic prefix.

FIG. 15 illustrates an Acknowledgement (ACK)/Negative Acknowledgement (NACK) frame 1500, which only consists of preamble 1501 and the FCH 1502. The bit fields in the FCH perform the ACK/NACK signaling.

In an alternative embodiment, such as in systems complying with the PLC G3 OFDM, each carrier signal may be modulated with Coherent/Differential Binary or Differential Quadrature Phase Shift Keying (BPSK, DBPSK or DQPSK) or Robust modulation. The PLC G3 Physical Layer Specification is the document titled “PLC G3 Physical Layer Specification” published by Électricité Réseau Distribution France (eRDF), the disclosure of which is hereby incorporated by reference herein in its entirety. Robust modulation is a robust form of DBPSK that provides extensive time and frequency diversity to improve the ability of the system to operate under adverse conditions. Forward error correction coding (FEC) is applied to both the frame control information (Super Robust encoding) and the data (concatenated Reed-Solomon and Convolutional Encoding) in the communication packet.

A mapping block assures that the transmitted signal conforms to a given Tone Map and Tone Mask. The Tone Map and Mask are concepts of the MAC layer. The Tone Mask is a predefined (static) system-wide parameter defining the start, stop and notch frequencies. The Tone Map is an adaptive parameter that, based on channel estimation, contains a list of carriers that are to be used for a particular communication between transmitters and receivers over the power lines. For example, carriers that suffer deep fades can be identified and avoided, and no information is transmitted on those carriers according to the Tone Map and Mask.

In BPSK, each frame control symbol uses a pre-defined phase reference, which is used as preamble. A binary sequence is encoded as a phase vector, where each entry is determined as a phase shift with respect to the phase reference vector φ. A phase shift of zero degrees indicates a binary “0”, and a phase shift of 180 degrees indicates a binary “1.” The mapping function for coherent BPSK must obey the Tone Mask. Thus carriers that are masked are not assigned phase symbols. The data encoding of the k-th subcarrier for coherent BPSK is defined below in the BPSK encoding Table 11.

TABLE 11

| Input Bit | Output Phase |
|---|---|
| 0 | φₖ |
| 1 | Φₖ + π |

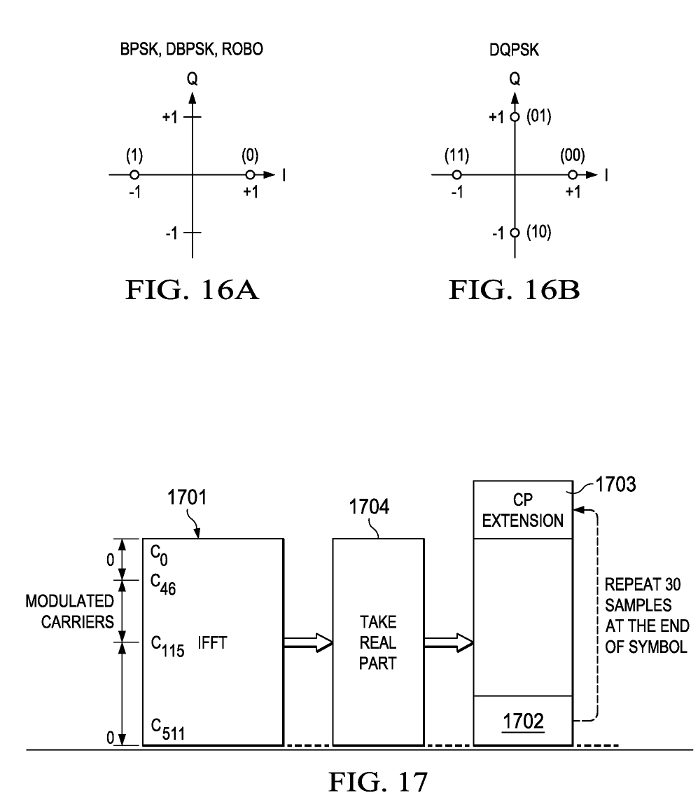

Data bits are mapped for differential modulation (DBPSK, DQPSK or Robust). Instead of using the phase reference vector φ, each phase vector uses the same carrier, previous symbol, as its phase reference. The first data symbol uses the pre-defined phase reference vector. The data encoding for Robust, DBPSK and DQPSK is illustrated in FIGS. 16A and B, where Ψₖ is the phase of the k-th carrier from the previous symbol. In DBPSK and Robust modulation, a phase shift of 0 degrees represents a binary “0” and a phase shift of 180 degrees represents a binary “1.” In DQPSK modulation, a pair of two bits is mapped to four different output phases. The phase shifts of 0, 90, 180, and 270 degrees represent binary “00”, “01”, “11”, and “10”, respectively. Table 12 illustrates the DBPSK and Robust Encoding Table of the k-th subcarrier. Table 13 illustrates the DQPSK Encoding Table of the k-th subcarrier.

TABLE 12

| Input Bit | Output Phase |
|---|---|
| 0 | Ψₖ |
| 1 | Ψₖ + π |

TABLE 13

| Input Bit | |
|---|---|
| Pattern (X, Y) | Output Phase |
| 00 | Ψₖ |
| 01 | Ψₖ + π/2 |
| 10 | Ψₖ + π |
| 11 | Ψₖ + 3π/2 |

In an alternative embodiment, the phase differences used to compute the “output phases” in Table 12 and Table 13 can be represented in a constellation diagram (with reference phase assumed equal to 0 degrees), as shown in FIGS. 16A and B.

As noted above, the OFDM signal can be generated using IFFT. An alternative embodiment of the IFFT block is illustrated in FIG. 17. IFFT block 1701 takes the 256-point IFFT of an input vector and generates the main 256 time-domain OFDM words pre-pended by 30 samples of cyclic prefix. This method uses the last 30 samples 1702 at the output of the IFFT and places them in front 1703 of the symbol. The useful output is the real part 1704 of the IFFT coefficients.

In addition to the differential modulation schemes outlined above, such as differential frequency modulation in the PRIME standard and differential time modulation in the G3 standard, it will be understood that coherent modulation may be used for the payload. Table 14 illustrates data mapping for data bits using coherent modulation according to one embodiment. The constant Ψ may be zero or any other phase value.

TABLE 14

| Input Bit | Output Phase |
|---|---|
| 0 | Ψ |
| 1 | Ψ + π |

Under channel and noise conditions typically observed in power line communications, coherent modulation may offer more than 2 dB performance gain over differential modulation. It is well known that coherent modulation with ideal channel estimates gives significant performance gains over differential modulation. However, two concerns have prevented widespread application of coherent modulation to narrowband PLC systems:

1. the accuracy of channel estimates in the presence of frequency-selective distortion and power line noise, and

2. the complexity of coherent modulation.

The above concerns can be alleviated by suitably designing the communication system to aid simple, robust implementations of coherent modulation.

Channel estimates can be obtained from two possible sources: the preamble sequence, such as the preamble in PPDU 600 (FIG. 6), and regular pilot tones transmitted on the time-frequency grid. In most implementations, both sources are used. Typically, an initial preamble-based channel estimate is generated and is then updated using pilot tones.

In one embodiment, the pilot tones are arranged in a periodic pattern so that the eighth tone in any given symbol is a pilot. The location of the pilot within each symbol is shifted by two tones every symbol. As a result, on every fourth symbol, pilots occur on the same tone.

The pilot overhead above is 12.5%. In an alternative embodiment, this can be reduced by transmitting pilots on every alternate symbol. This increases the pilot periodicity to eight, but the resulting performance degradation is likely to be small since the PLC channel does not vary significantly within a few symbols.

Channel estimation is done by time interpolation followed by frequency interpolation. In one implementation of time interpolation, for every new symbol, the previous three pilots on the same frequency are filtered to estimate the interpolated channel estimate on that tone. At the end of this process, interpolated estimates are available on every second tone on each OFDM symbol. These are then interpolated in frequency to estimate the channel. Since only past pilots are used, channel estimation is causal and does not have large latency or memory requirements. The above sequence of two one-dimensional filters is not always optimum, but it is easy to implement and is shown by simulation to achieve near-optimum performance. Various other implementations of channel estimation, which trade-off accuracy for complexity are possible.

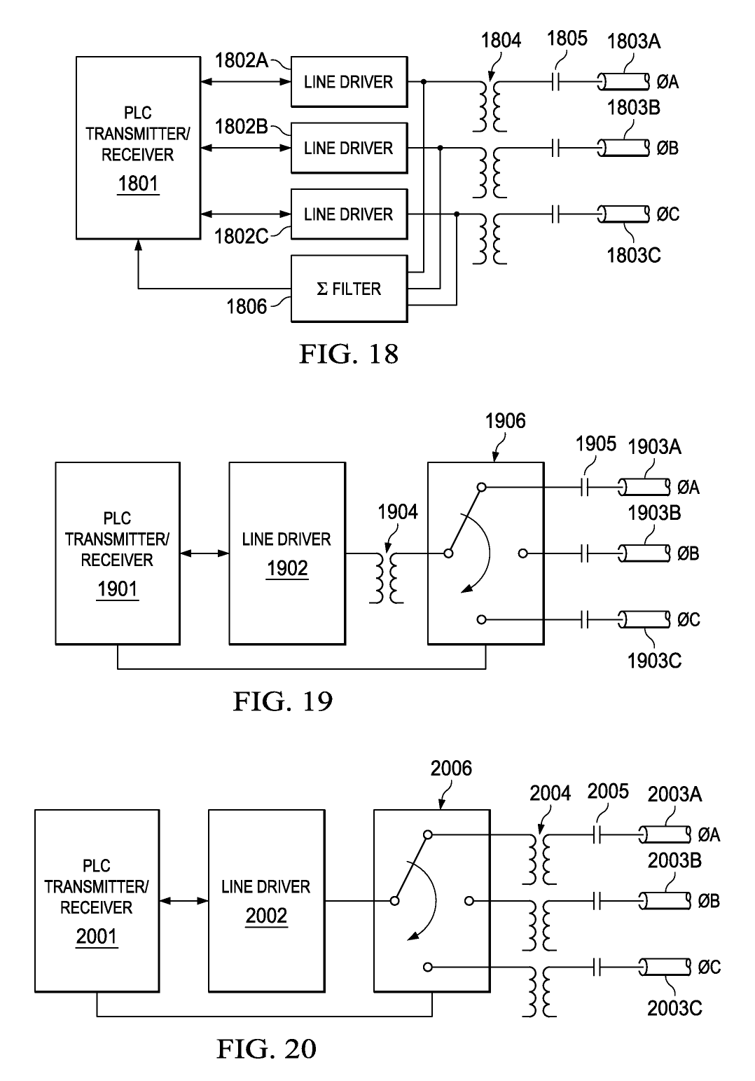

FIGS. 18-20 illustrate alternative embodiments of connecting a power line transmitter/receiver to three phase power lines, such as LV and MV lines, as disclosed in pending U.S. patent application Ser. No. 12/839,315, titled “OFDM Transmission Methods in Three Phase Modes,” filed Jul. 19, 2010, the disclosure of which is hereby incorporated by reference herein in its entirety.

FIG. 18 illustrates the connection between the power line communication transmitter and/or receiver circuitry to the power lines according to one embodiment of the invention. PLC transmitter/receiver 1801 may function as the transmitter or receiver circuit in the embodiments described above. PLC transmitter/receiver 1801 generates precoded signals for transmission over the power line network. Each output signal, which may be a digital signal, is provided to a separate line driver circuit 1802A-C. Line drivers 1802A-C comprise, for example, digital-to-analog conversion circuitry, filters and line drivers that couple signals from PLC transmitter/receiver 1801 to power lines 1803A-C. A transformer 1804 and coupling capacitor 1805 link each analog circuit/line driver 1802 to its respective power line 1803A-C. Accordingly, in the embodiment illustrated in FIG. 18, each output signal is independently linked to a separate, dedicated power line.

FIG. 18 further illustrates a alternate receiver embodiment. Signals are received on power lines 1803A-C, respectively. In one embodiment, each of the received signals may based individually through coupling capacitors 1805, transformers 1804, and line drivers 1802 to PLC transmitter/receiver 1801 for detection and receiver processing of each signal separately. Alternatively, the received signals may be routed to summing filter 1806, which combines all of the received signals into one signal that is routed to PLC transmitter/receiver 1801 for receiver processing.

FIG. 19 illustrates an alternative embodiment in which PLC transmitter/receiver 1901 is coupled to a single line driver 1902, which is in turn coupled to power lines 1903A-C by a single transformer 1904. All of the output signals are sent through line driver 1902 and transformer 1904. Switch 1906 selects which power line 1903A-C receives a particular output signal. Switch 1906 may be controlled by PLC transmitter/receiver 1901. Alternatively, switch 1906 may determine which power line 1903A-C should receive a particular signal based upon information, such as a header or other data, in the output signal. Switch 1906 links line driver 1902 and transformer 1904 to the selected power line 1903A-C and associated coupling capacitor 1905. Switch 1906 also may control how received signals are routed to PLC transmitter/receiver 1901.

FIG. 20 is similar to FIG. 19 in which PLC transmitter/receiver 1901 is coupled to a single line driver 1902. However, in the embodiment of FIG. 20, power lines 2003A-C are each coupled to a separate transformer 2004 and coupling capacitor 2005. Line driver 2002 is coupled to the transformers 2004 for each power line 2003 via switch 2006. Switch 2006 selects which transformer 2004, coupling capacitor 2005, and power line 2003A-C receives a particular signal. Switch 2006 may be controlled by PLC transmitter/receiver 2001, or switch 2006 may determine which power line 2003A-C should receive a particular signal based upon information, such as a header or other data, in each signal. Switch 2006 also may control how received signals are routed to PLC transmitter/receiver 2001.

Many modifications and other embodiments of the invention will come to mind to one skilled in the art to which this invention pertains having the benefit of the teachings presented in the foregoing descriptions, and the associated drawings. Therefore, it is to be understood that the invention is not to be limited to the specific embodiments disclosed. Although specific terms are employed herein, they are used in a generic and descriptive sense only and not for purposes of limitation.

What is claimed is:

1. A transmitter, comprising:
a convolutional encoder;
a robust coder coupled to the convolutional encoder, the convolutional encoder and robust coder receiving data from a Media Access Control (MAC) layer and creating a coded signal;
a modulator generating a modulated signal from the coded signal; and
an Orthogonal Frequency Division Multiplexing (OFDM) circuit coupled to the differential modulator and generating an OFDM output signal adapted to be transmitted on a power line network.

2. The transmitter of claim 1, wherein the robust coder is a repetition 2 code circuit coupled to an output of the convolutional encoder.

3. The transmitter of claim 1, wherein the robust coder is a repetition 2 code circuit coupled to an input of the differential modulator.

4. The transmitter of claim 1, wherein the robust coder adds a repetition N code to the data from the MAC layer.

5. The transmitter of claim 1, wherein the robust coder adds an outer code prior to the convolutional encoder.

6. The transmitter of claim 1, wherein the robust coder is a Reed Solomon coder coupled to an input of the convolutional encoder.

7. The transmitter of claim 6, wherein the Reed Solomon coder partitions the data from the MAC layer into subgroups, each of the subgroups having a size less than 256 bytes.

8. The transmitter of claim 7, wherein the sizes of each subgroup are selected based upon a type of modulation applied by the differential modulator.

9. A transmitter, comprising:
an outer code circuit;
a convolutional encoder coupled to the output of the outer code circuit;
a repetition N coder coupled to output of the convolutional encoder, the outer code circuit, the convolutional encoder, and the repetition N coder receiving data from a Media Access Control (MAC) layer and creating a coded signal;
a differential modulator generating a differentially modulated signal from the coded signal, wherein differential modulation is performed across adjacent frequency tones; and
an Orthogonal Frequency Division Multiplexing (OFDM) circuit coupled to the differential modulator and generating an OFDM output signal adapted to be transmitted on a power line network.

10. The transmitter of claim 9, wherein the repetition N coder is a repetition 2 code circuit.

11. The transmitter of claim 9, wherein the outer code circuit is a Reed Solomon coder.

12. The transmitter of claim 11, wherein the Reed Solomon coder partitions the data from the MAC layer into subgroups, each of the subgroups having a size less than 256 bytes.

13. The transmitter of claim 12, wherein the sizes of each subgroup are selected based upon a type of modulation applied by the differential modulator.

14. A method of modulating and coding a signal, comprising:
convolutionally encoding data from a Media Access Control (MAC) layer;
robust coding the data from the MAC layer either before or after the convolutional encoding;
differentially modulating the coded data; and
Orthogonal Frequency Division Multiplexing (OFDM) the differentially modulated, coded data to create an OFDM output signal adapted to be transmitted on a power line network.

15. The method of claim 14, wherein the robust coding is repetition N coding.

16. The method of claim 14, wherein the robust coding is repetition N repetition coding.

17. The method of claim 14, wherein the robust coding adds an outer code prior to the convolutional encoding.

18. The method of claim 14, wherein the robust coding is Reed Solomon coding performed prior to the convolutional encoding.

19. The method of claim 18, further comprising:
partitioning the data from the MAC layer into subgroups, each of the subgroups having a size less than 256 bytes.

20. The method of claim 19, wherein the sizes of each subgroup are selected based upon a type of modulation applied by the differential modulating.

21. A method for decoding a signal, comprising:
receiving a PHY protocol data unit (PPDU) from a power line network;
decoding a first header in the PPDU;
verifying whether the first header was successfully decoded according to a first format;
decoding a second header in the PPDU;
verifying whether the second header was successfully decoded according to a second format; and
decoding a payload in the PPDU according to either the first or second format.

22. The method of claim 21, wherein the first format is a PRIME R1.3E format.

23. The method of claim 22, wherein the second format identifies modulation and coding not available in the PRIME R1.3E format.

24. The method of claim 21, wherein the PPDU payload is decoded according to the first format when the first header was successfully decoded and the second header was not successfully decoded.

25. The method of claim 21, wherein the PPDU payload is decoded according to the second format when the first header was successfully decoded and the second header was successfully decoded.

26. The method of claim 21, wherein the PPDU payload is decoded according to the second format when the first header was not successfully decoded and the second header was successfully decoded.
